(19) United States
(12) Patent Application Publication
(10) Pub. No.: US 2024/0210153 A1
(43) Pub. Date: Jun. 27, 2024

(54) REMOVABLE FITTING FRAME SUITABLE FOR MOUNTING ON A MONITORING DEVICE FOR INSPECTING SMALL PARTS

(71) Applicant: Atmen Solution - Toni Orhanovic, Dombresson (CH)

(72) Inventor: Toni Orhanovic, Dombresson (CH)

(73) Assignee: Atmen Solution - Toni Orhanovic, Dombresson (CH)

(21) Appl. No.: 18/563,297

(22) PCT Filed: May 19, 2022
(86) PCT No.: PCT/IB2022/054690

§ 371 Date: Nov. 21, 2023

(30) Foreign Application Priority Data
May 27, 2021 (CH) 00602/21

(51) Int. Cl. G01B 5/00; G04D 7/00

(52) U.S. Cl. CPC G01B 5/0004; G04D 7/004

(57) ABSTRACT

The invention relates to a removable fitting frame (10) suitable for being removably mounted on an optical monitoring device, particularly a motorised monitoring device, for inspecting components (100, 102, 104, 106, 108). The fitting frame (10) comprises a rigid cage (10a), a component holder (22; 24; 26; 34; 40) mounted inside the rigid cage (10a), and at least one rotating part (44a, 44b) serving as an interface between the rigid cage (10a) and at least one rotating element (68a, 68b) of the monitoring device or between the rigid cage (10a) and an intermediate element (64a, 64b) mounted on the rotating element (68a, 68b) when the fitting frame (10) is mounted on the monitoring device, so as to use the torque generated by the monitoring device during the inspection of the component (100, 102, 104, 106, 108) in order to enable the rotation of said rigid cage (10a) and/or of said rotating part (44a, 44b) about an axis of rotation coaxial with the axis of rotation of said at least one rotating element (68a, 68b).

### TECHNICAL FIELD

The present invention concerns a fitting frame suitable for mounting in a removable manner on a motorized monitoring device, in particular an optical monitoring device, for dimensional and aesthetic monitoring of small parts. The present invention also concerns a motorized monitoring device including the removable fitting frame and a frame support that may be motorized or not.

### PRIOR ART

Product quality control in the laboratory or during manufacture often involves inspection by means of an optical monitoring device. For example there are known optical monitoring devices of the following types:
standard or analog profile projectors,
2D, 3D profile projectors with computer processing of the image. Two families are mainly distinguished: full field detection machines with no XY localization constraints and coordinate machines with XY localization constraints.
2D profile projectors may be equipped with optical systems oriented vertically or horizontally. They may equally be equipped with rotary modules that enable axial rotation of the parts of revolution (such as machine-made parts). They may equally be equipped with a motor drive system for the rotary module and a motor drive system for moving the optical detection assembly, thereby enabling 360° scanning of the profile of the parts over all their length.

Depending on the shape of the parts, the geometries to be monitored and equally the type of machine used, diverse methods of positioning the part on the machine are frequently employed, in particular:
free positioning, typically employed for parts that remain flat and perpendicular to the optical axis of the monitoring/measuring device, and
aligned or constrained positioning, typically employed for parts that are not systematically positioned perpendicularly to or aligned with the optical axis (for example cylindrical parts including various diameters or flat surfaces that are too small to guarantee the part remaining in equilibrium).

For 2D profile projector type devices, with vertical or horizontal optical systems and equipped with devices for rotating the parts, known supports mainly make it possible to hold the parts clamped between spindles, clamps, jaws or constrained between two points (one of the points being fixed to the motorized rotary base of the machine and the other point being fixed to a rotary counter-block (tailstock) but not necessarily motorized and axially aligned with the rotary base and the distance of which can be adjusted/adapted depending on the length of the parts to be measured). The disadvantages of known supports are that they are not suitable for very small parts, the clamping elements and the adjustment of the axial retaining elements being too coarse or of complicated repeatability.

### BRIEF SUMMARY OF THE INVENTION

One object of the present invention is consequently to propose a support for positioning parts during their inspection that are free of the limitations of known supports.

More particularly, one object of the present invention is to propose a multipurpose support in terms of machine compatibility as much as of the variety of parts to be measured.

Another object of the invention is to propose a support including interchangeable, standardized and combinable elements in order to enable a variety of fitting configurations, being able to employ a variety of possible positioning methods and thus to enable positioning suitable for specific optical inspection requirements and parts.

Another object of the invention is to propose a support including interchangeable and finely adjustable elements in order to enable complex adjustments.

Another object of the invention is to propose a support ensuring high precision and repeatability of positioning.

Another object of the invention is to enable rapid alternation of fitting and thus of the parts monitored on the monitoring device.

Another object of the invention is to enable rotation (revolution) of the fitting and/or of the parts for optimum use of monitoring means capable of processing dynamic or three-dimensional measurements or using a compiled succession of static measurements corresponding to progressive rotation (revolution) of the parts.

Another object of the invention is to enable an increase in the throughput and the efficiency of the monitoring process through the possibility of prepositioning the parts outside the machine on removable and interchangeable inspection frames, thus enabling positioning of the parts in masked time, while the machine is measuring the previous part, and then executing a rapid exchange between the two fittings and continuing the measurement sequence with a minimal loss of time between parts.

In accordance with the invention, these objects are achieved in particular by means of a removable fitting frame adapted to be mounted in a removable manner on an optical monitoring device, in particular a motorized monitoring device, for inspecting components. The fitting frame includes a rigid cage, a component support mounted inside the rigid cage and at least one rotary part serving as an interface between the rigid cage and at least one rotary element of the monitoring device or between the rigid cage and an intermediate element mounted on the rotary element when the fitting frame is mounted on the monitoring device so as to use the torque generated by the control device when inspecting the component, to enable rotation of the rigid cage and/or the rotary part about a rotation axis coaxial with the rotation axis of said at least one rotary element.

In accordance with one embodiment, the rotary part is connected to the rotary element of the monitoring device and to the component support so that:
the rigid cage can be pivoted synchronously with the component support about said rotation axis, preferably by means of a friction drive, and
at least a part of the component support can pivot about said rotation axis while the rigid cage remains immobile.

In accordance with one embodiment, said at least one rotary part is connected to the component support by a cylindrical part passing completely through at least one coupling part of the rigid cage so that:
the fitting frame can be driven in rotation about said rotation axis by friction, or
the cylindrical part can pivot relative to the fitting frame.

In accordance with one embodiment, the cylindrical part is a fit inside a bearing or a smooth bearing arranged within the thickness of said coupling part.

In accordance with one embodiment, the fitting frame includes first and second rotary parts arranged on either side of the rigid cage so that the rotation axis of said first and second rotary parts is coaxial with first and second rotary elements of the monitoring device when the fitting frame is mounted on the monitoring device.

In accordance with one embodiment, first and second coupling tips are secured to the first and second rotary parts respectively for axial centering and coupling of the cage to the motorized monitoring device so that said cage can pivot about said rotation axis.

In accordance with one embodiment, the coupling tip of each rotary part is adapted to cooperate with first and second complementary coupling tips respectively that are secured to the first and second rotary elements respectively of the monitoring device or first and second intermediate elements respectively that are mounted on said first and second rotary elements, respectively.

In accordance with one embodiment, the coupling tip of the first and second rotary parts is a permanent magnet. The first and second complementary coupling tips are also permanent magnets.

In accordance with one embodiment, when the fitting frame is mounted on the monitoring device, the permanent magnet of one of the first and second rotary parts of the fitting frame and the corresponding permanent magnet of one of the first and second rotary elements of the monitoring device, or one of the first and second intermediate elements mounted on said first and second rotary elements respectively, are arranged so that the polarity of their respective portions facing one another are opposed in order for the magnets of this first set of magnets to be attracted and in contact. The permanent magnet of the other of the first and second rotary parts of the fitting frame and the corresponding permanent magnet of the other of the first and second rotary elements of the monitoring device, or the other of the first and second intermediate elements mounted on said first and second rotary elements respectively, are arranged facing one another. The polarity of their respective portions facing one another are also opposed in order for the magnets of this second set of magnets also to be attracted by one another in order to align them axially.

In accordance with one embodiment, the magnets of the second set of magnets are in contact with or at a distance from one another when the fitting frame is mounted on the monitoring device.

In accordance with one embodiment, the rigid cage includes two longitudinal edges and two transverse edges connecting the respective ends of the two longitudinal edges. The first and second rotary parts are each mounted on the respective transverse edge of the rigid cage.

In accordance with one embodiment, the fitting frame further includes at least one first and one second longitudinal slide arranged on either side of said rotation axis as well as at least one sliding transverse part including a part of the component support.

In accordance with one embodiment, the sliding transverse part includes a pointer pointing in the direction of metric graduations arranged along at least one of the two longitudinal edges as well as an immobilizing member for immobilizing the sliding part as a function of the indication given by the pointer facing the metric graduations.

In accordance with one embodiment, the component support is a magnetic support including first and second magnetic tips arranged facing one another in order to be able to position a component to be inspected between the first and second magnetic tips so that one end of the component is in contact with one of the first and second magnetic tips and so that the other end of the component is at a distance from the other of the first and second magnetic tips while being aligned on said rotation axis.

In accordance with one embodiment, the component support is a V support including first and second blocks mounted on respective first and second transverse parts sliding along two slides. The V support further includes a first and a second V profile blade structure secured to the first, respectively the second, block so that the two V profile blades are arranged facing one another. An adjustment member is mounted on each block in order to be able to adjust the position of each block along an axis perpendicular to the rotation axis of the rigid cage.

In accordance with one embodiment, each block includes a pointer arranged facing metric graduations situated on each transverse sliding part supporting the corresponding block.

In accordance with one embodiment, the component support further includes adjustable alignment abutments and a tension wire enabling retention of a component to be inspected.

In accordance with one embodiment, the component support is a suction support including a suction nozzle and an alignment counter-abutment arranged facing one another.

In accordance with one embodiment, the component support is an ultrasound support including at least one first and one second transducer arranged relative to one another or a transducer arranged facing a reflecting element in order to create an interference pattern enabling retention of small parts.

In accordance with one embodiment, the rigid cage includes adjustment screws enabling fine adjustment of the flatness of said cage when the fitting frame is positioned in a frame support placed on a horizontal monitoring table.

Another aspect of the invention relates to a frame support adapted to receive the rigid cage of the fitting frame. The frame support includes a frame including at least three tabs arranged in corresponding relationship with the adjustment screws when the rigid frame is mounted in the support in order for the end of each adjustment screw to be able to come into contact with a respective tab for fine adjustment of the flatness of said cage when said support is positioned on a horizontal monitoring table.

Another aspect of the invention relates to a motorized frame support adapted to receive the rigid cage of the fitting frame. The frame support includes a frame including at least three tabs arranged in corresponding relationship with the adjustment screws when the rigid cage is mounted in the frame of the frame support in order for the end of each adjustment screw to be able to come into contact with a respective tab for fine adjustment of the flatness of the rigid cage when the frame support is positioned on a horizontal monitoring table. The motorized frame support further includes an electric motor and a coupling tip secured to the shaft of the electric motor and adapted to be coupled to the rotary part of the fitting frame when said cage is mounted in the support frame.

In accordance with one embodiment, the motorized frame support further includes a variable speed or rotation angle drive for driving the rotation of at least one part of the component support.

Another aspect of the invention relates to a motorized monitoring device, in particular an optical monitoring device, for inspecting components. The monitoring device includes a lighting system, a video camera, a motorized first rotary element and a non-motorized second rotary element. The first and second rotary elements are adapted to pivot about an identical rotation axis and respectively include first and second interfaces respectively including first and second coupling tips adapted to be coupled to the first and second coupling tips respectively of the first and second rotary parts of the fitting frame in order for the latter to be able to pivot about the identical rotation axis. The lighting system and the video camera are arranged on either side of said rotation axis.

In accordance with one embodiment, the motorized monitoring device further includes an immobilization device including an interface mounted on the second non-motorized rotary element of the first and second rotary elements as well as a pivoting part including an abutment. The pivoting part is adapted to pivot from a disengaged position of the fitting frame to an engaged position in which the abutment comes into contact with the fitting frame in order to be able to stop the rotation of the latter whilst ensuring that said at least one part of the component support can continue to pivot coaxially about the revolution axis of the component to be inspected.

### BRIEF DESCRIPTION OF THE FIGURES

Embodiments of the invention are indicated in the description illustrated by the appended figures in which:

FIG. 1 depicts a perspective view of a fitting frame coupled to the first and second rotary elements of the monitoring device with a representation of a lighting system and a video camera of the monitoring device in accordance with one embodiment;

FIGS. 2a to 2d depict the rigid cage in accordance with different embodiments;

FIG. 3 is a view of the fitting frame from FIG. 1 when laid flat;

FIG. 4 is a view in section of FIG. 3 on a plane X-Y;

FIG. 5 is a side view of the fitting frame from FIG. 3;

FIG. 6 is an axial section of FIG. 5;

FIG. 7 is a view to a larger scale of the component support and of the component to be inspected from FIG. 3;

FIG. 8 is a view of the fitting frame in accordance with another embodiment when laid flat;

FIG. 9 is a view to a larger scale of the component support and of the component from FIG. 8;

FIG. 10 is a view of the fitting frame in accordance with another embodiment when laid flat;

FIG. 11 is a perspective view of the fitting frame from FIG. 10;

FIG. 12 is a view to a larger scale of the component support and of the means for adjustment of that support:

FIG. 13 is a view to a larger scale of the component support and of the component from FIG. 10;

FIG. 14 is a perspective view of FIG. 13;

FIG. 15 is a view of the fitting frame in accordance with another embodiment when laid flat;

FIG. 16 is a view to a larger scale of the component support from FIG. 15;

FIG. 17 is a view of the fitting frame in accordance with another embodiment when laid flat;

FIG. 18 is a view to a larger scale of the component support and of components to be inspected from FIG. 17;

FIG. 19 is a profile view of the method of positioning the fitting frame relative to two intermediate elements that are fixed to the rotary elements of the monitoring device;

FIG. 20 is a view to a larger scale of the coupling between the magnetic tip and one of the first and second rotary parts of the fitting frame and the magnetic tip of one of the first and second intermediate elements that are fixed to the rotary elements of the monitoring device;

FIG. 21 is a view to a larger scale of the coupling between the magnetic tip of the other of the first and second rotary parts of the fitting frame and the magnetic tip of the other of the first and second intermediate elements that are fixed to the rotary elements of the monitoring device;

FIG. 22 illustrates the principle of the toric magnetic fields that ensure correct axial alignment of the two magnetic tips from FIG. 20;

FIG. 23 illustrates the principle of the toric magnetic fields that ensure correct axial alignment of the two magnetic tips from FIG. 21;

FIG. 24 is a perspective view of the immobilization device of the fitting frame in a non-operational configuration;

FIG. 25 is a perspective view of the immobilization device of the fitting frame in an operational configuration;

FIG. 26 is a perspective view of the fitting frame in accordance with one embodiment coupled to the first and second rotary elements of the monitoring device and in which the immobilization device is released from the frame so that it can pivot about its rotation axis;

FIG. 27 is a perspective view of the fitting frame in accordance with another embodiment coupled to the first and second rotary elements of the monitoring device and in which the immobilization device is in contact with the frame in order to prevent it from being able to pivot about its rotation axis;

FIGS. 28a and 28b form a perspective view of the fitting frame coupled to the first and second rotary elements of the monitoring device in accordance with another embodiment:

FIG. 29 is a perspective view of a monitoring device including a horizontal table and a vertical optical axis, a frame support in which the fitting frame is arranged being disposed on the horizontal table;

FIG. 30 is a perspective view of the frame support from FIG. 29;

FIG. 31 is a view to a larger scale of one of the rotary parts of the fitting frame including a notched ring enabling manual rotation of the parts to be inspected;

FIG. 32 is a perspective view of a motorized frame support in which the fitting frame is disposed on the horizontal table of a monitoring device;

FIG. 33 is a perspective view of the motorized frame support from FIG. 32, and

FIG. 34 depicts the magnetic coupling between a first magnetic tip mounted on the shaft of the motor of the motorized frame support and a second magnetic tip secured to the rotary part of the fitting frame.

### EMBODIMENTS OF THE INVENTION

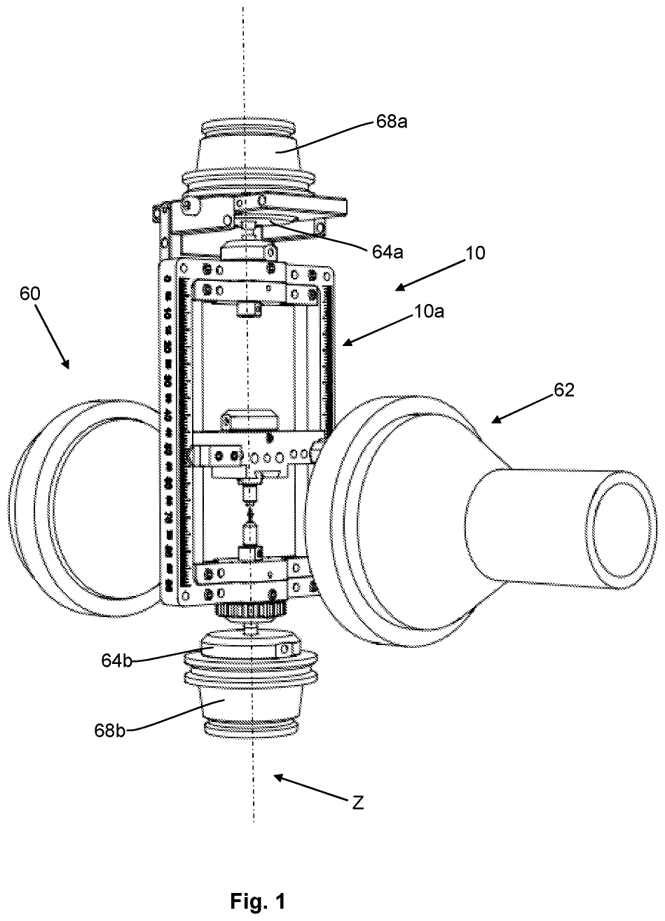

Referring to FIG. 1, the fitting frame 10 is positioned on and axially coupled to first and second intermediate elements 64a, 64b respectively connected to first and second rotary elements 68a, 68b of a monitoring device. These first and second rotary elements 68a, 68b are adapted to be driven in rotation by a motor of the monitoring device. The first and second rotary elements are arranged on either side of the fitting frame 10 in order for the latter to be able to pivot about a central axis passing through the center of the fitting frame and coinciding with the rotation axis Z of the first and second rotary elements 64a, 64b of the monitoring device.

The monitoring device includes a lighting system 60 and a video camera 62 arranged on either side of the fitting frame 10 in a plane perpendicular to the rotation axis Z.

The fitting frame 10 is able to receive interchangeable, standardized and combinable elements in order to allow a variety of fitting configurations, which can take the form of a variety of possible positioning methods and thus enable positioning suitable for specific and varied optical inspection requirements and parts.

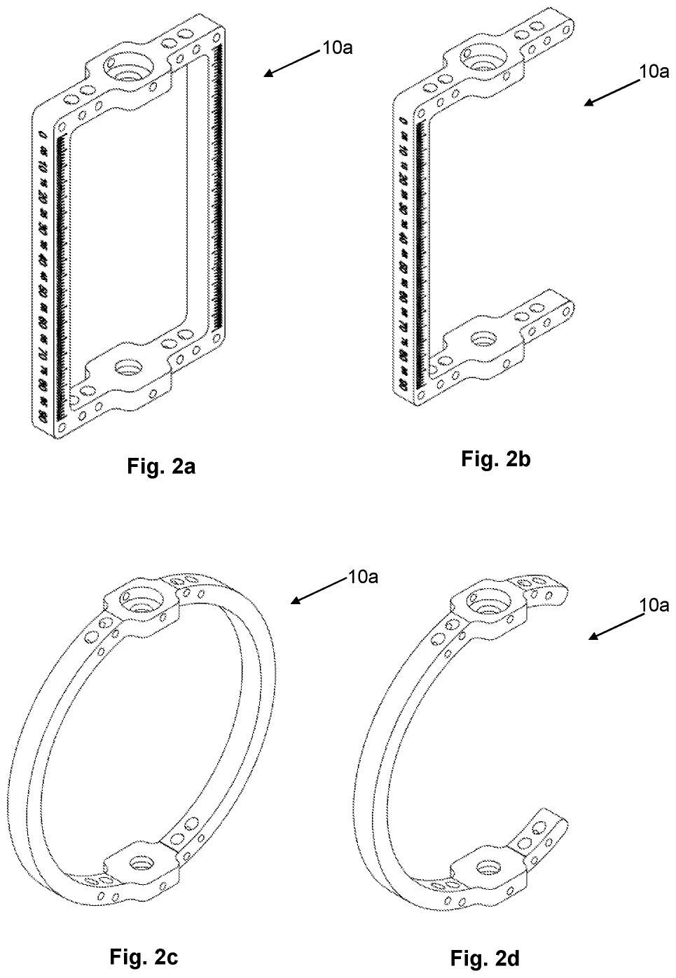

The fitting frame 10 includes a rigid cage 10a inside which a component support is mounted. In the context of the present invention the rigid cage 10a may take various forms that may be closed or open. For example, the rigid cage may be a rectangular cage as per FIG. 2a, a frame including only three rectilinear sides similar to a [as per FIG. 2b, a circular cage as per FIG. 2c or a C-shaped cage as per FIG. 2d.

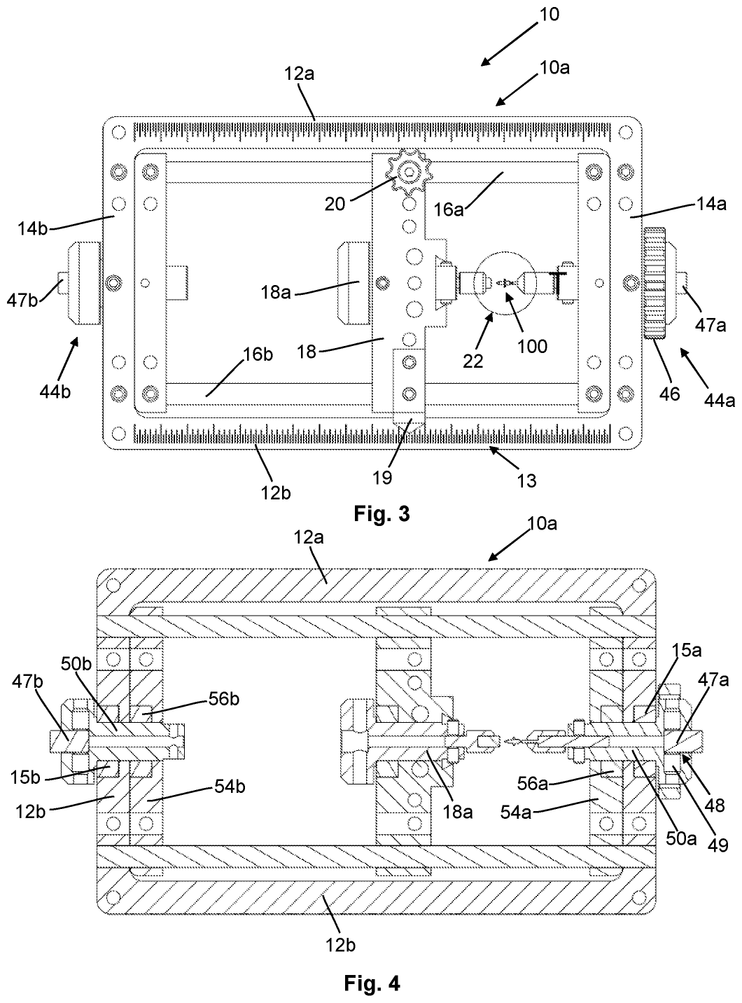

FIGS. 3 to 7 represent one example of the configuration of a fitting frame 10 for the inspection of a component 100. In FIG. 3 the fitting frame 10 includes a rigid rectangular cage 10a comprising two longitudinal edges 12a, 12b and two transverse edges 14a, 14b connecting respective ends of the two longitudinal edges 12, 12b. A component support 22 is mounted inside the rigid cage 10a.

The fitting frame 10 further includes first and second rotary parts 44a, 44b each of which is mounted on the respective transverse edge 14a, 14b of the rigid cage 10a and which respectively include first and second coupling tips 47a, 47b for the axial centering and coupling of the fitting frame 10 to the monitoring device so that the frame 10 is able to pivot about the rotation axis Z (FIG. 1) of the monitoring device as per the description thereof hereinafter.

In FIG. 4 each coupling tip 47a, 47b is mounted inside a cylindrical hole 48 in each rotary part 44a, 44b that is concentric with the rotation axis of the rotary parts. A plurality of screws 49 retain each coupling tip 47a, 47b in its respective hole.

According to FIG. 3 the fitting frame 10 further includes first and second longitudinal slides 16a, 16b arranged inside the rigid cage 10a and on either side of the rotation axis Z from FIG. 1 as well as a sliding transverse part 18. The sliding transverse part 18 includes a pointer 19 pointing in the direction of metric graduations 13 arranged along at least one of the two longitudinal edges 12a, 12b of the rigid cage 10a as well as an immobilizing member 20, for example in the form of a screw, for immobilizing the sliding part 18 as a function of the indication given by the pointer 19 facing the metric graduations 13.

Referring to FIG. 4, each rotary part 44a, 44b includes a cylindrical part 50a, 50b passing completely through the respective transverse edges 14a, 14b of the rigid cage 10a as well as a fixed transverse support 54a, 54b. The respective cylindrical parts 50a, 50b are fitted inside a first bearing 15a, 15b arranged within the thickness of the respective lateral edges 14a, 14b of the rigid cage as well as inside a second bearing 56a, 56b arranged within the thickness of the respective transverse supports 54a, 54b so that either the rigid cage 10a can be driven in rotation about the rotation axis Z by friction or the cylindrical part 50a, 50b can pivot relative to the rigid cage 10a, which remains immobile. The bearings may be replaced by any other means enabling driving in rotation of the rigid cage 10a by friction or rotation of the cylindrical part 50a, 50b relative to the cage, for example by a smooth bearing.

One end of the cylindrical part 50a includes a first magnetic kit 22a whereas the sliding part 18 includes an axial part 18a having one end provided with a second magnetic tip 22b arranged facing the first magnetic tip 22a, as can be seen in FIG. 7 in particular.

The sliding part 18 enables precise adjustment of the distance between the two magnetic tips 22a, 22b thanks to the pointer 19 moving along the metric graduations 13. This enables precise positioning of the component 100 to be inspected, in this example a timepiece shaft, as a function of its dimensional characteristics. The magnetic field produced by the magnetic properties of the two tips and their disposition relative to one another ensures that one end of the timepiece shaft 100 is in contact with the first magnetic tip 22a whereas the other end of the timepiece shaft 100 is at a distance from the second magnetic tip 22b but aligned with the central axis of the fitting frame 10. The timepiece shaft 100 is therefore coaxial with the rotation axis Z of the monitoring device and coupled to it in rotation when the fitting frame 10 is positioned on and axially coupled to the first and second rotary elements 68a, 68b of the monitoring device.

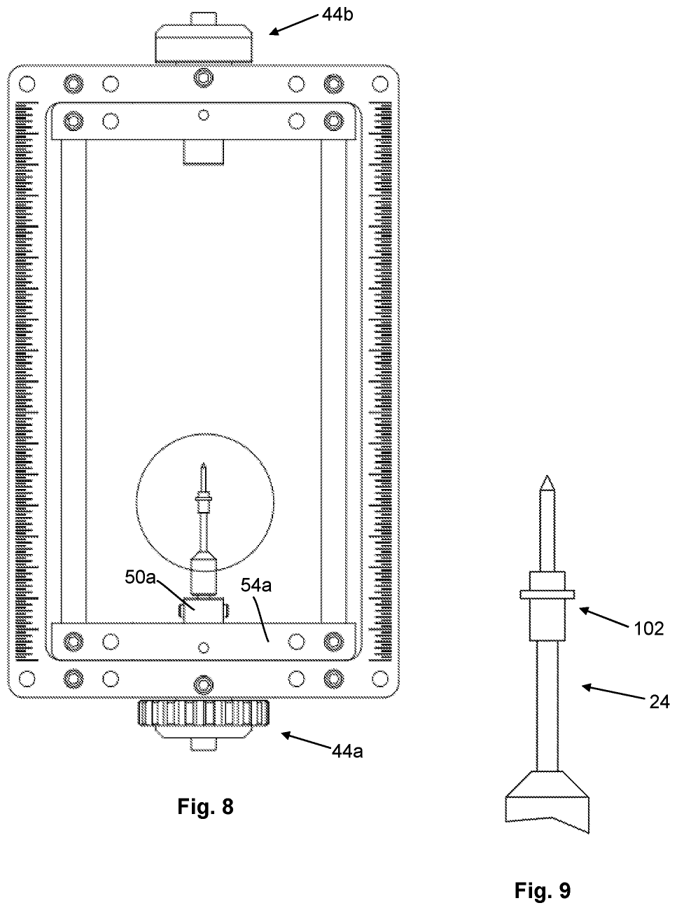

In accordance with another example of the configuration of the fitting frame depicted in FIGS. 8 and 9 an interchangeable precision arbor 24 for a component 102 including an axial bore or a hole is mounted on and secured to the cylindrical part 50a of the rotary part 44a arranged to be driven in rotation by the monitoring device.

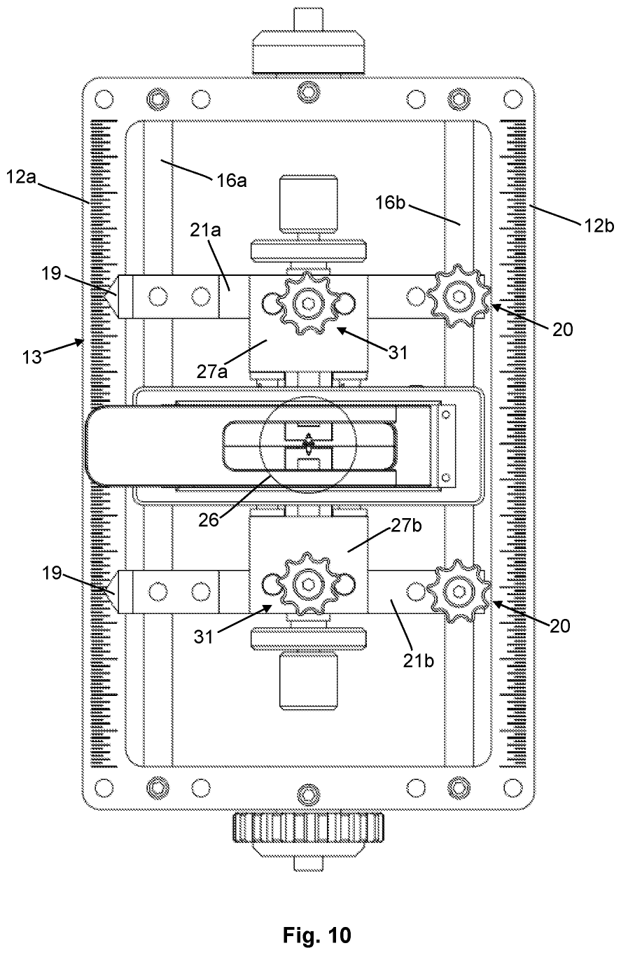

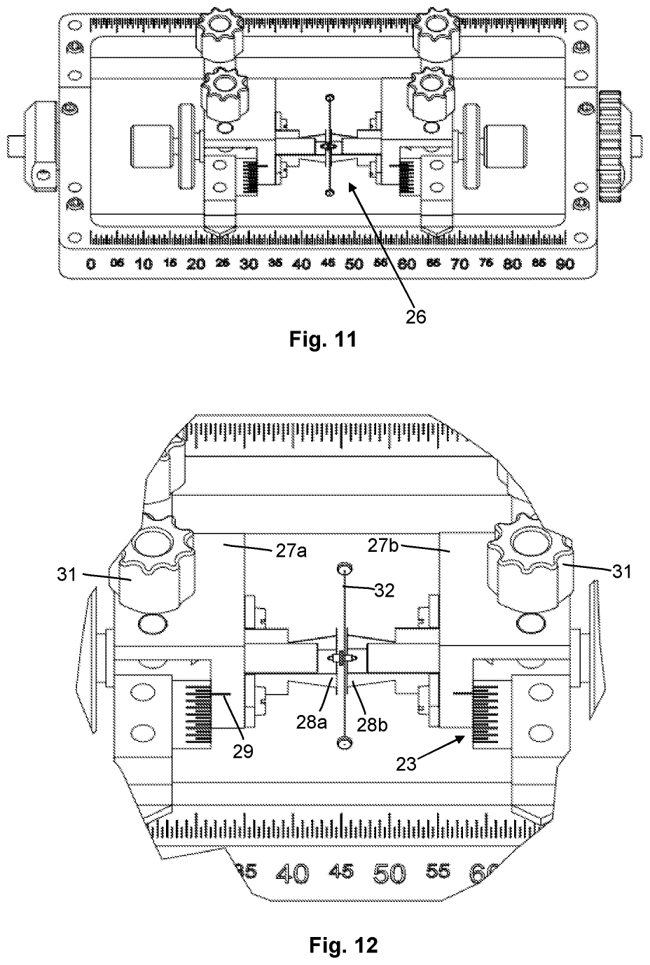

In accordance with another example of the configuration of the fitting frame 10 depicted in FIGS. 10 to 14 a V support 26 is mounted inside the rigid cage 10a. The V support includes first and second blocks 27a, 27b respectively mounted on first and second transverse parts 21a, 21b sliding along two slides 16a, 16b. First and second V-profile blade structures 28a, 28b are secured to the first and second blocks 27a, 27b respectively so that the two V-profile blades are arranged facing one another. An adjustment member 31, for example in the form of a screw, is mounted on each block 27a, 27b in order to be able to adjust the position of each block along an axis perpendicular to the rotation axis of the rigid cage. To this end each block 27a, 27b includes a pointer 29 arranged facing metric graduations 23 situated on each sliding transverse part 21a, 21b supporting the corresponding block, as can be seen in FIG. 12 in particular, or on a part secured to the corresponding sliding transverse part.

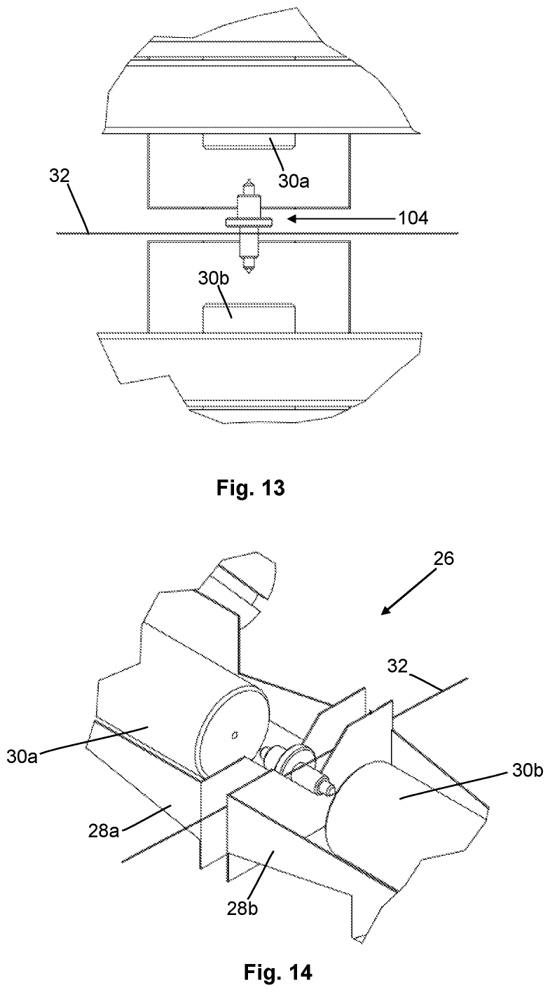

Just as in the embodiment depicted in FIG. 3 in particular, the first and second sliding transverse parts 21a, 21b each include a pointer 19 pointing in the direction of metric graduations 13 arranged along at least one of the two longitudinal edges 12a, 12b of the rigid cage 10a as well as an immobilizing member 20 for immobilizing each sliding part 21a, 21b as a function of the indication given by the pointer 19 facing the metric graduations 13 in order to enable fine adjustment of the distance between the two V blades. The support further includes adjustable alignment abutments 30a, 30b and a tension wire module 32 for holding non-magnetic small parts 104 with no usable axial hole or bore, as depicted in FIGS. 13 and 14.

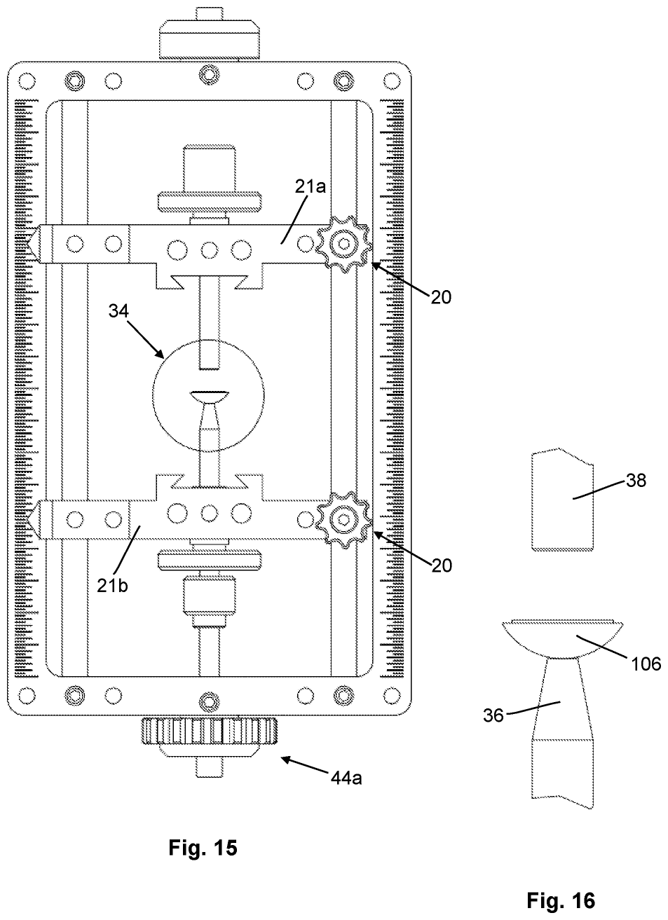

FIGS. 15 and 16 depict another example of the configuration of the fitting frame 10 including a suction support 34 including a suction nozzle 36 secured to the rotary part 44a and an alignment counter-abutment 38 enabling holding of non-magnetic small parts 106 with no usable axial hole or bore and not having sufficient bearing geometries for positioning on V-profile blades.

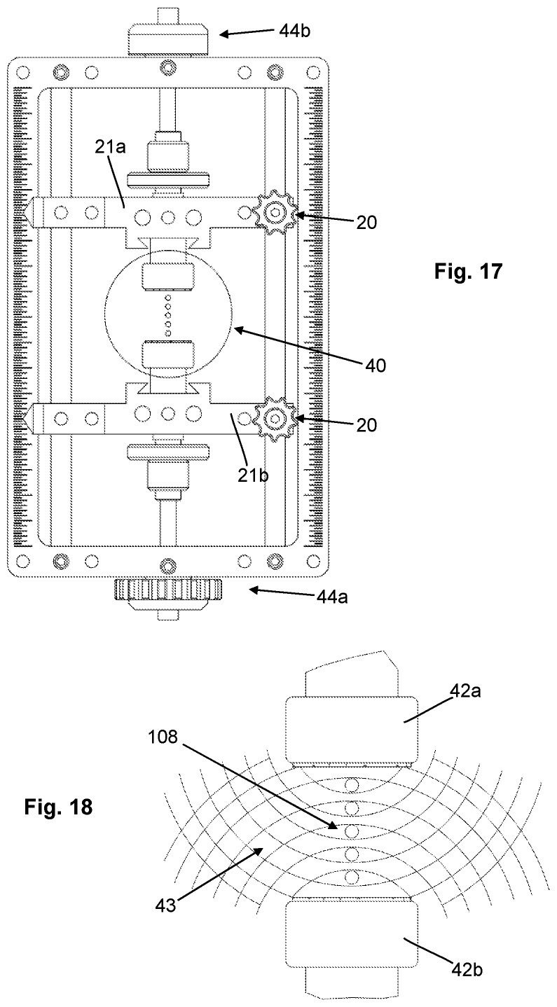

In accordance with another example of the configuration the fitting frame 10 depicted in FIGS. 17 and 18 it includes an ultrasound support 40 including two sliding blocks 21a, 21b provided with high-frequency transducers 42a, 42b enabling holding of sufficiently light small parts 108 the geometry of which lends itself to repeatable alignment in the interference pattern 43 (meshing, interleaving of waves) generated by the frequencies emitted by the transducers.

The same function may equally be obtained with only one transducer and a counter-element reflecting the waves produced by the transducer. The same function can equally be obtained with two or more transducers disposed on the same sliding block with all the transducers disposed at an angle of inclination such that their axes converge at a common point that is on the axis of the rotary part 44a.

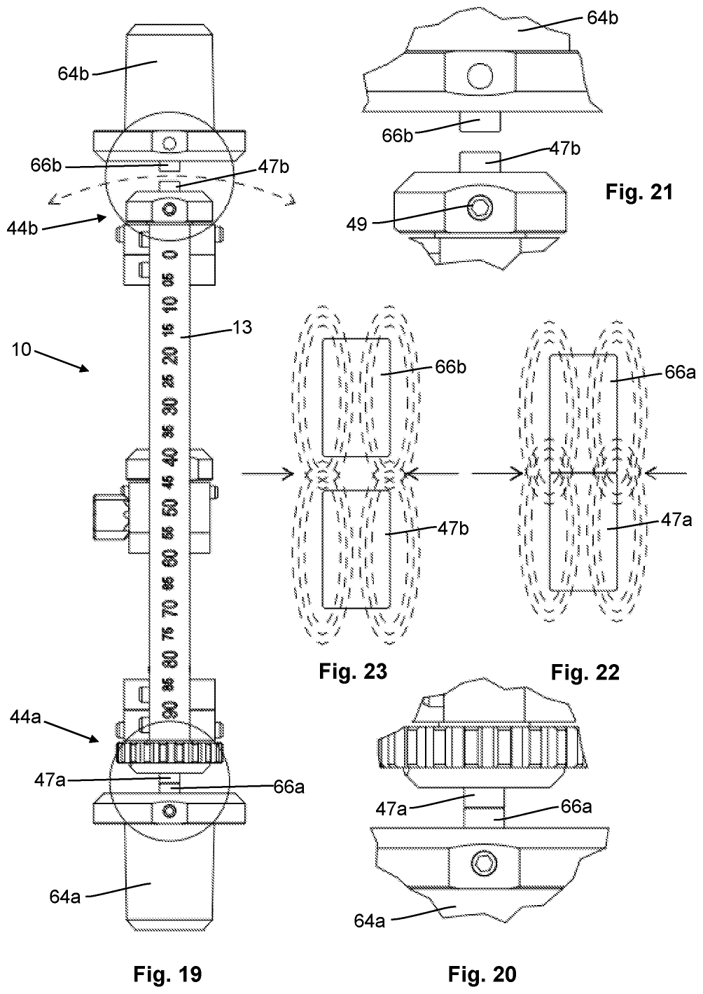

Referring to FIGS. 19 to 23, in this example the monitoring frame 10 of the monitoring device as depicted in FIG. 19 is put into position and removed by magnetic coupling. To this end the coupling tip 47a, 47b of the first and second rotary parts 44a, 44b is a permanent magnet whereas the first and second coupling complementary tips 66a, 66b secured to the first and second intermediate elements 64a, 64b respectively defining the interface with the rotary elements of the monitoring device are also permanent magnets.

More particularly, when the fitting frame 10 is mounted on the monitoring device according to FIG. 19 the permanent magnet 47a of one of the first and second rotary parts 44a of the fitting frame 10 and the corresponding permanent magnet 66a of one of the first and second intermediate elements 64a defining the interface with the motorized rotary element of the monitoring device are arranged so that the polarities of their respective portions facing one another are opposite in order for the magnets 47a, 66a of this first set of magnets to be in contact, as depicted in FIGS. 20 and 22 in particular.

The permanent magnet 47b of the other of the first and second rotary parts 44b of the fitting frame 10 and the corresponding permanent magnet 66b of the other of the first and second intermediate elements 64b defining the interface with the non-motorized rotary element of the monitoring device are also arranged so that the polarities of their respective portions facing one another are opposite in order for the magnets 47a, 66a of the second set of magnets to be attracted despite the intentional residual space between them, and therefore axially aligned, as depicted in FIGS. 21 and 23 in particular.

The permanent magnets 47a, 47b, 66a, 66b are preferably magnets that generate magnetic fields that are toric and diffuse axially at the ends of the first and second rotary parts 44a, 44b, having the advantage of enabling good alignment of the fitting frame 10 so that the central axis of the fitting frame 10 coincides with the rotation axis Z of the first and second rotary elements 64a, 64b of the monitoring device (FIG. 1).

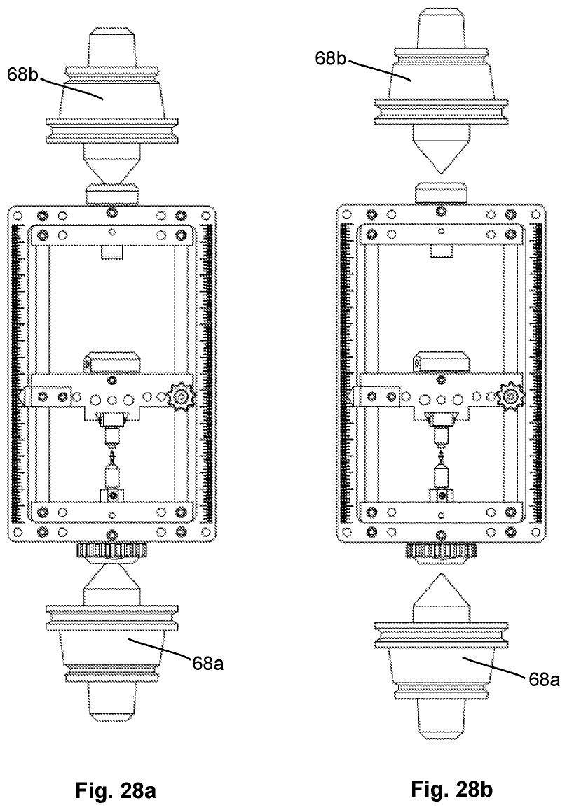

It is obviously possible to replace the magnetic coupling method by various pairs of profiled tips or for example by a bayonet system. Coupling between two tips as depicted in FIGS. 28a, 28b may equally be employed. In this case one of the tips is fixed to the motorized first rotary element 68a of the monitoring device while the other tip is fixed to the non-motorized second rotary element 68b of the monitoring device. The magnetic solution nevertheless remains the preferred solution because it is better in terms of simplicity and rapidity of placement. In fact, the space existing between the magnets 47b, 66b (FIG. 19) enables free tilting of the monitoring frame 10 once it is outside the magnetic field and thus simplifies fitting it and removing it.

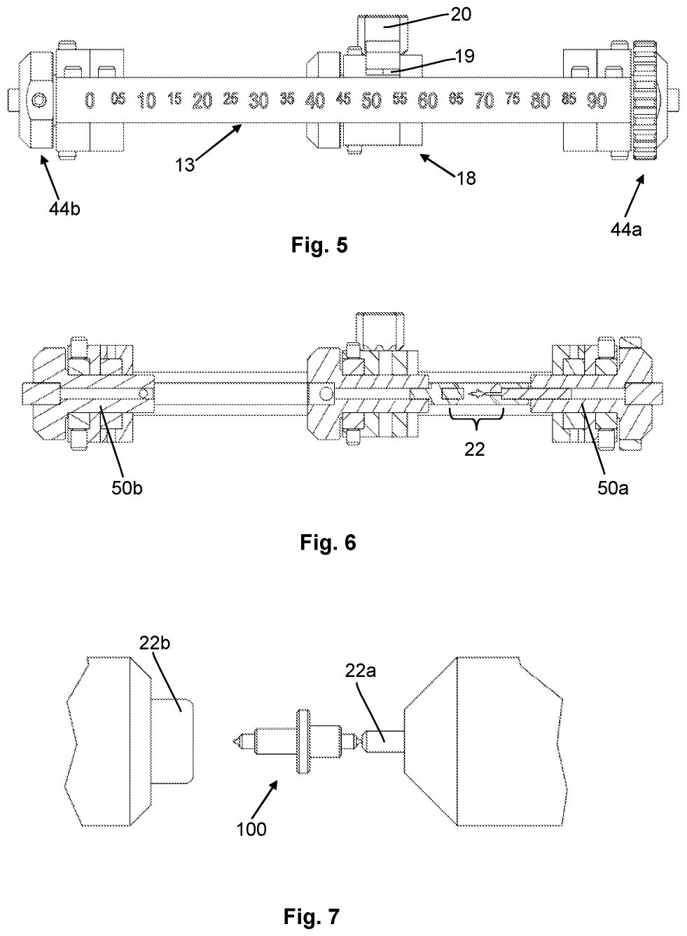

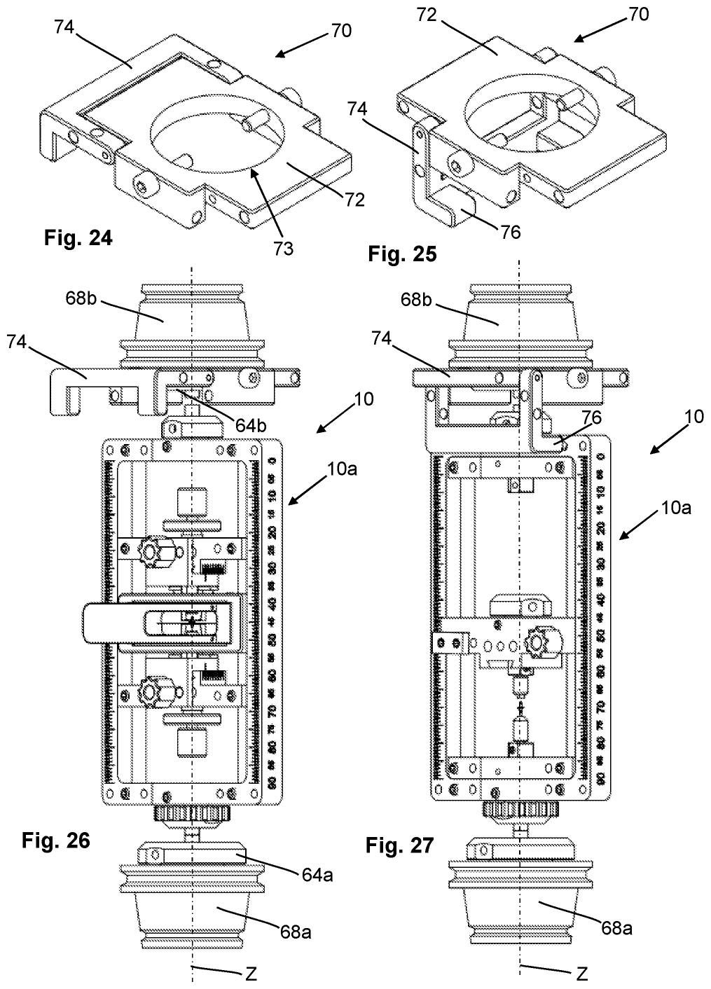

An immobilizing device 70 depicted in FIGS. 24 and 25 in a non-operational configuration and an operational configuration, respectively, is coupled to one of the first and second intermediate elements 64a, 64b defining the interface with the non-motorized rotary element 68b in order for the fitting frame 10 to be able to turn about the rotation axis Z, as depicted in FIG. 26, or prevented from rotating, as depicted in FIG. 26. In the latter case, the component 100 to be inspected bears on the part 22a of the component support that pivots about the rotary part 44a of the fitting frame 10 (FIG. 5 to 7).

The immobilizing device 70 more particularly includes an interface 72 mounted on one of the first and second intermediate elements 64a, 64b defining the interface with the non-motorized rotary element 68b that is by definition decoupled from the rotation of the motorized rotary element 68a of the monitoring device, as well as a pivoting part 74 including an abutment 76. The pivoting part 74 is adapted to pivot from a disengaged position of the fitting frame 10 to an engaged position in which the abutment 76 comes into contact with one of the transverse edges 14a, 14b of the fitting frame 10 in order to stop the rotation thereof whereas the part 22a of the component support 22 continues to pivot about the revolution axis of the component 100 to be inspected and by definition the rotation axis of the monitoring device (FIGS. 6-7).

In the case of using a fitting frame 10 the elements of which for holding the components to be inspected are not secured to one or the other of the rotary parts 44a, 44b of the fitting frame 10, such as for example the V profile blade blocks in FIG. 26 (see also FIG. 10), as used on a monitoring device motorized in rotation, it is necessary for the fitting frame 10 to be able to turn freely in order for the device to be able to scan/measure the greatest possible portion of the component in rotation. In this case the pivoting part 74 of the immobilizing device 70 is disengaged from the fitting frame in order to allow free rotation of the frame.

In the case of using a fitting frame in which at least a part of the support of the components to be measured is secured to one or the other of the rotary parts 44a, 44b of the fitting frame 10, such as for example the component support 22 with magnetic tips in FIG. 27 (see also FIG. 3), so that the part 22a of the support 20 can turn freely, it is preferable that the fitting frame 10 is not able to turn. This in fact prevents the lateral edges 12a, 12b of the frame interfering with imaging or scanning during rotation of the component 100. In this case the pivoting part 74 of the immobilizing device 70 is lowered in order to block rotation of the fitting frame.

The conical shape of the first and second rotary elements 64a, 64b in FIGS. 1, 16, 23 and 24 that define the interface with the rotary elements of the monitoring device can of course vary in order to be compatible with the configuration of the clamping or fixing modules present on the monitoring device used.

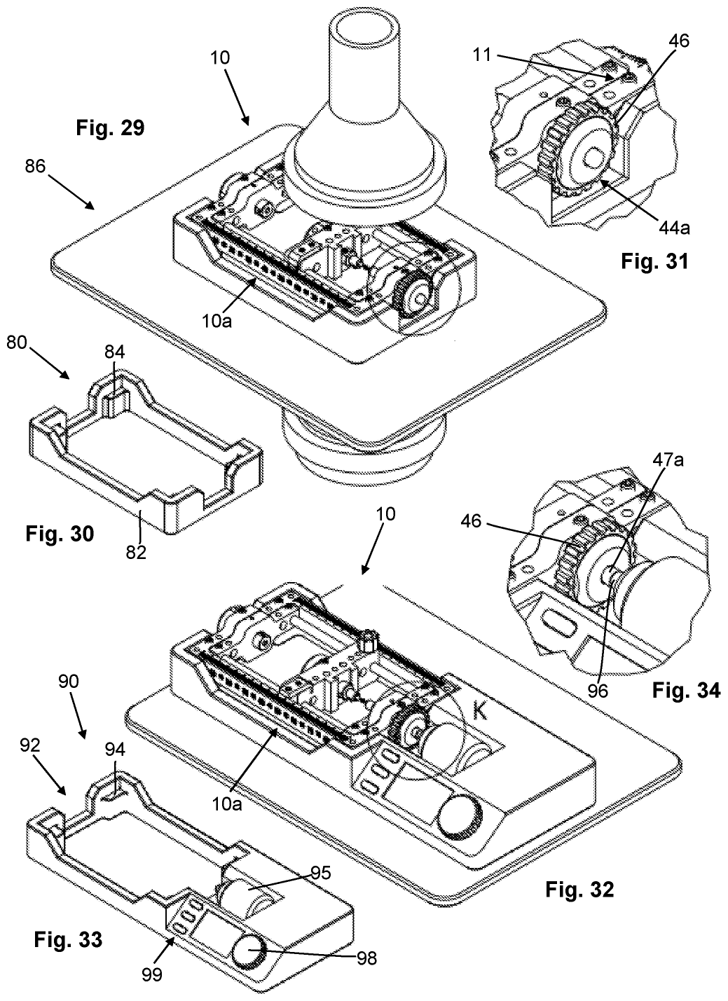

In the framework of maximum compatibility with various machines and their respective monitoring methods, FIGS. 29 to 31 depict an embodiment in horizontal use on a monitoring device the optical monitoring axis of which is placed vertically and which does not employ motorized rotation.

A frame support 80 depicted in FIG. 30 is adapted to receive the rigid cage 10a of the fitting frame 10 in FIG. 29. In that figure the frame support 80 is positioned on a horizontal monitoring table 86 the optical monitoring axis of which is placed vertically relative to the monitoring table.

The frame support 80 includes a rectangular frame 82 including four tabs 84 arranged at the four corners of the rectangular frame 82 in corresponding relationship with adjustment screws 11 (FIG. 31) of the rigid cage 10a of the fitting frame in order for the end of each adjustment screw 11 to be able to come into contact with the respective tab 84 when the rigid cage is positioned in the frame support 80.

This makes it possible to guarantee fine adjustment of the flatness of the cage 10a of the fitting frame 10 in order to guarantee perfect perpendicularity thereof and consequently of the components to be inspected relative to the optical axis of the monitoring device. The frame support 80 has no bottom and is therefore open in order to enable backlighting of the components to be inspected.

The frame 82 of the frame support is not necessarily rectangular and may be modified as a function of the shape of the rigid cage 10a. The frame 82 may moreover include only three tabs, that number of tabs being sufficient to guarantee the stability of the rigid cage when it is mounted in the frame of the support.

In FIG. 31 one of the rotary parts 47a of the fitting frame 10 includes a preferably notched ring 46 in order to enable manual rotation of the components to be inspected if successive 2D views taken at various degrees of rotation are required.

FIGS. 32 to 34 depict a motorized frame support 90 adapted to receive the fitting frame (FIG. 32). As in the simple frame support depicted in FIG. 30, in FIG. 32 the motorized frame support 90 is positioned on a horizontal monitoring table the optical monitoring axis of which is placed vertically relative to the monitoring table.

The motorized frame support 90 includes a rectangular frame 92 including four tabs 94 arranged at the four corners of the rectangular frame 92 in corresponding relationship with the adjustment screws 11 of the rigid cage 10a of the fitting frame in order for the end of each adjustment screw 11 to be able to come into contact with the respective tab 94 for fine adjustment of the flatness of the rigid cage in order to guarantee perfect perpendicularity thereof relative to the optical axis of the monitoring device.

The motorized frame support 90 further includes an electric motor 95 and a coupling tip 96 secured to the shaft of the electric motor is adapted to be coupled to the coupling tip 47a of the rotary part 44a of the fitting frame 10 when the latter is mounted in the rectangular frame 92, as depicted in FIG. 32.

The motorized frame support 90 further includes a variable speed drive and is at an angle of inclination 98 for monitoring the rotation of a part 22a of the component support 22 (FIG. 3) in order to enable motorized rotation of the components 100 to be inspected to enable successive 2D images to be captured at various degrees of rotation. The motorized frame support includes a plurality of programmable keys 99 in order to control the motor so that the rotation of the part 22a of the support 20 (FIGS. 3 and 7) corresponds to predetermined degrees of rotation to enable successive 2D views to be captured at various degrees of rotation.

The motorized frame support 90 may further be connected to the monitoring device so that the sequences of rotations can be performed so as to be coordinated with the sequences of measurements and of processing data from the monitoring device.

Just as in the simple frame support depicted in FIG. 30, the rectangular frame 92 of the motorized frame support 90 has no bottom and is therefore open in order to enable backlighting of the components to be inspected.

In the FIG. 32 embodiment the coupling/driving between the coupling tip 96 of the shaft of the motor 95 and the tip 47a of the rotary part 44a of the fitting frame 10 is effected by magnetic coupling thanks to two magnetized tips. It is however easy to imagine other coupling/driving systems, for example driving by profiled tips or by a notched belt slaved directly to the notched ring 46.

Finally, just as in the simple frame support, the frame 92 of the motorized frame support is not necessarily rectangular and may be adapted as a function of the shape of the rigid cage 10a. The frame 92 can further include only three tabs, this number of tabs being sufficient to guarantee the stability of the rigid cage when it is mounted in the frame of the motorized frame support.

### LIST OF REFERENCE NUMBERS

Removable fitting frame 10
   Rigid cage 10a
   Adjustment screw 11
   Longitudinal edges 12a, 12b
      Metric graduations 13
   Transverse edges 14a, 14b
      Bearings 15a, 15b
   Longitudinal slides 16a, 16b
   Sliding transverse part 18
      Axial part 18a
      Pointer 19
      Immobilizing member 20
   First and second sliding transverse parts 21a, 21b
      Metric graduations 23
   Component support
      Magnetic support 22
         First and second magnetic tips 22a, 22b
      Precision arbor support 24 (alternative)
      V support 26 (alternative)
         First and second blocks 27a, 27b
         Pointer 29
         Adjustment member 31
         First and second V supports V 28a, 28b
         First and second alignment sliding abutments 30a, 30b
         Tension wire 32
      Suction support 34 (alternative)
         Suction nozzle 36
         Alignment counter-abutment 38
      Ultrasound support 40 (alternative)
         First and second transducers 42a, 42b
         Interference pattern 43
   First and second rotary parts 44a, 44b
      Ring 46
      Coupling tips 47a, 47b
         Magnetic tips
      Cylindrical housing 48
      Fixing screw 49
      Cylindrical part 50a, 50b
         Distal fixing part 52
   Transverse supports 54a, 54b
      Bearings 56a, 56b
Monitoring device
   Lighting system 60
   Video camera 62
   First and second intermediate elements 64a, 64b
      First and second complementary coupling tips 66a, 66b
         Magnetic tips
   First and second rotary elements 68a, 68b
Immobilizing device 70
   Interface 72
      Cylindrical opening 73
   Pivoting part 74
   Abutments 76
Frame support 80
   Rectangular frame 82
      Tabs 84
Horizontal monitoring table 86
Motorized frame support 90
   Rectangular frame 92
      Tabs 94
   Motor 95
      Coupling tip 96
   Variable speed drive 98
   Programmable keys 99
Component 100, 102, 104, 106, 108

1. A removable fitting frame adapted to be mounted in a removable manner on an optical monitoring device, in particular a motorized monitoring device, for inspecting components, the fitting frame including a rigid cage, at least one component support mounted inside the rigid cage and at least one rotary part serving as an interface between the rigid cage and at least one rotary element of the monitoring device or between the rigid cage and an intermediate element mounted on the rotary element when the fitting frame is mounted on the monitoring device so as to use the torque generated by the control device when inspecting the component, to enable rotation of said rigid cage and/or said rotary part about a rotation axis coaxial with the rotation axis of said at least one rotary element, wherein the rotary part is connected to the rotary element of the monitoring device and to the component support so that:
the rigid cage can be pivoted synchronously with the component support about said rotation axis, preferably by means of a friction drive, or
at least a part of the component support can pivot about said rotation axis while the rigid cage remains immobile.

2. The fitting frame as claimed in claim 1 in which said at least one rotary part is connected to the component support by a cylindrical part passing completely through at least one coupling part of the rigid cage so that:
the fitting frame can be driven in rotation about said rotation axis by friction, or
the cylindrical part can pivot relative to the fitting frame.

3. The fitting frame as claimed in claim 2 in which the cylindrical part is a fit inside a bearing or a smooth bearing arranged within the thickness of said coupling part.

4. The fitting frame as claimed in claim 1 including first and second rotary parts arranged on either side of the rigid cage so that the rotation axis of said first and second rotary parts is coaxial with first and second rotary elements of the monitoring device when the fitting frame is mounted on the monitoring device.

5. The fitting frame as claimed in claim 4 in which first and second coupling tips are secured to the first and second rotary parts respectively for axial centering and coupling of the cage to the motorized monitoring device so that said cage can pivot about said rotation axis.

6. The fitting frame as claimed in claim 5 in which the coupling tip of each rotary part is adapted to cooperate with first and second complementary coupling tips respectively that are secured to the first and second rotary elements respectively of the monitoring device or first and second intermediate elements respectively that are mounted on said first and second rotary elements respectively.

7. The fitting frame as claimed in claim 6 in which the coupling tip of the first and second rotary parts is a permanent magnet, said first and second complementary coupling tips also being permanent magnets.

8. The fitting frame as claimed in claim 7 in which when the fitting frame is mounted on the monitoring device the permanent magnet of one of the first and second rotary parts of the fitting frame and the corresponding permanent magnet of one of the first and second rotary elements of the monitoring device or one of the first and second intermediate elements mounted on said first and second rotary elements respectively are arranged so that the polarity of their respective portions facing one another are opposed in order for the magnets of this first set of magnets to be attracted and in contact while the permanent magnet of the other of the first and second rotary parts of the fitting frame and the corresponding permanent magnet of the other of the first and second rotary elements of the monitoring device or the other of the first and second intermediate elements mounted on said first and second rotary elements respectively are arranged facing one another, the polarity of their respective portions facing one another also being opposed in order for the magnets of this second set of magnets also to be attracted by one another in order to align them axially.

9. The fitting frame as claimed in claim 8 in which the magnets of said second set of magnets are in contact with or at a distance from one another when the fitting frame is mounted on the monitoring device.

10. The fitting frame as claimed in claim 4 in which the rigid cage is a rectangular frame having two longitudinal edges and two transverse edges connecting the respective ends of the two longitudinal edges, said first and second rotary parts each being mounted on the respective transverse edge of the rectangular frame.

11. The fitting frame as claimed in claim 10 further including at least one first and one second longitudinal slide arranged on either side of said rotation axis as well as at least one sliding transverse part including a part of the component support.

12. The fitting frame as claimed in claim 11 in which the sliding transverse part includes a pointer pointing in the direction of metric graduations arranged along at least one of the two longitudinal edges as well as an immobilizing member for immobilizing the sliding part as a function of the indication given by the pointer facing the metric graduations.

13. The fitting frame as claimed in claim 4 in which the component support is a magnetic support including first and second magnetic tips arranged facing one another in order to be able to position a component to be inspected between the first and second magnetic tips so that one end of the component is in contact with one of the first and second magnetic tips and so that the other end of the component is at a distance from the other of the first and second magnetic tips while being aligned on said rotation axis when the fitting frame is mounted on the monitoring device.

14. The fitting frame as claimed in claim 4 in which the component support is a V support including first and second blocks mounted on respective first and second transverse sliding parts along two slides, a first and a second V profile blade structure being secured to the first, respectively the second, block so that the two V profile blades are arranged facing one another, an adjustment member being mounted on each block in order to be able to adjust the position of each block along an axis perpendicular to the rotation axis of the rigid cage.

15. The fitting frame as claimed in claim 14 in which each block includes a pointer arranged facing metric graduations situated on each transverse sliding part supporting the corresponding block or on a part secured to each transverse sliding part.

16. The fitting frame as claimed in claim 14 in which the component support further includes adjustable alignment abutments and a tension wire enabling retention of a component to be inspected.

17. The fitting frame as claimed in claim 4 in which the component support is a suction support including a suction nozzle and an alignment counter-abutment arranged facing one another.

18. The fitting frame as claimed in claim 4 in which the component support is an ultrasound support including at least one first and one second transducer arranged relative to one another or a transducer arranged facing a reflecting element in order to create an interference pattern enabling small parts to be retained by levitation in the interference pattern.

19. The fitting frame as claimed in claim 1 in which the rigid cage includes adjustment screws enabling fine adjustment of the flatness of said cage when the fitting frame is positioned in a frame support placed on a horizontal monitoring table.

20. A frame support adapted to receive the rigid cage of the fitting frame as claimed in claim 4, including a frame including at least three tabs arranged in corresponding relationship with the adjustment screws in order for the end of each adjustment screw to be able to come into contact with a respective tab when the rigid cage is mounted in the frame for fine adjustment of the flatness of said cage when said supports positioned on a horizontal monitoring table.

21. A motorized frame support adapted to receive the rigid cage of the fitting frame as claimed in claim 19, including a frame including at least three tabs arranged in corresponding relationship with the adjustment screws when the rigid cage is mounted in the frame of the frame support in order for the end of each adjustment screw to be able to come into contact with a respective tab for fine adjustment of the flatness of the rigid cage when said support is positioned on a horizontal monitoring table, the motorized frame support further including an electric motor and a coupling tip secured to the shaft of the electric motor and adapted to be coupled to the rotary part of the fitting frame when said cage is mounted in the support frame.

22. The motorized frame support as claimed in claim 21 further including a variable speed or rotation angle drive for driving the rotation of at least one part of the component support.

23. A motorized monitoring device, in particular an optical monitoring device, for inspecting components, including a lighting system, a video camera, a motorized first rotary element and a non-motorized second rotary element, the first and second rotary elements being adapted to pivot about the identical rotation axis and respectively including first and second interfaces respectively including first and second coupling tips adapted to be coupled to the first and second coupling tips respectively of the first and second rotary parts of the fitting frame as claimed in claim 5 in order for the fitting frame to be able to pivot about the identical rotation axis, the lighting system and the video camera being arranged on either side of said rotation axis.

24. The motorized monitoring device as claimed in claim 23 further including an immobilization device including an interface mounted on the second non-motorized rotary element of the first and second rotary elements as well as a pivoting part including an abutment, said pivoting part being adapted to pivot from a disengaged position of the fitting frame to an engaged position in which the abutment comes into contact with the fitting frame in order to be able to stop the rotation of the latter whilst ensuring that said at least one part of the component support can continue to pivot coaxially about the revolution axis of the component to be inspected.
